(19) United States
(12) Patent Application Publication
(10) Pub. No.: US 2010/0127735 A1
(43) Pub. Date: May 27, 2010

(54) MIXER CIRCUIT AND MIXER CIRCUIT ARRANGEMENT

(76) Inventor: Wen Hu Zhao, Singapore (SG)

Correspondence Address: Altera Law Group, LLC, 220 S 6 St Suite 1700, Minneapolis, MN, 55402, US

(21) Appl. No.: 12/447,494

(22) PCT Filed: Oct. 31, 2007
(86) PCT No.: PCT/SG07/00366

§ 371 Date: Dec. 22, 2009

Related U.S. Application Data
(60) Provisional application No. 60/863,732, filed on Oct. 31, 2006.

(51) Int. Cl. H02M 11/00

(52) U.S. Cl. 327/103

(57) ABSTRACT

A mixer circuit is provided. The mixer circuit comprises: a voltage-to-current converter stage; a switching stage comprising a plurality of switches, the switching stage being coupled with the voltage-to-current converter stage to controlled passing electrical current from the voltage-to-current converter stage through the switches; and a frequency conversion stage coupled to the switching stage. A mixer circuit arrangement is also provided.

The present application claims the benefit of U.S. provisional application 60/863,732 (filed on 31 Oct. 2006), the entire contents of which are incorporated herein by reference for all purposes.

### FIELD OF THE INVENTION

This invention relates to a mixer circuit and a mixer circuit arrangement.

### BACKGROUND OF THE INVENTION

In a MB-OFDM UWB (Multi-Band Orthogonal Frequency Division Multiplexing Ultra-Wide Band) spectrum, one of the challenges is to design a frequency synthesiser that can generate multiple carriers which can span across several GHz, with the ability to hop frequencies in less than about 9.47 ns. To avoid interference to Industrial, Scientific and Medical (ISM) applications using the frequencies of 2.4 GHz and 5 GHz, the spurious tones of mixing output are required to be below −50 dBc.

Known multiplexers that switch channel frequencies have a high power consumption and occupy a larger silicon area due to the use of multiple phase-locked loops (PLL). Another known fast hopping channel frequency device makes use of the frequency conversion function of known SSB (Single Side Band) mixers. Fast frequency hopping realized through known SSB mixers need auxiliary circuits to select the polarity of input signals to generate either up-side or down-side mixing output. Such auxiliary circuits include dc sources, inverting amplifiers, switches, ROM, DAC and so on, leading to a complex circuit structure. Such known SSB mixers are unable to maintain the purity of the generated carriers.

There is thus a need for a SSB mixer circuit that addresses one or more of the above problems.

### SUMMARY OF THE INVENTION

In a first aspect of the invention, a mixer circuit is provided, comprising: a voltage-to-current converter stage; a switching stage comprising a plurality of switches, the switching stage being coupled with the voltage-to-current converter stage to controlled passing electrical current from the voltage-to-current converter stage through the switches; and a frequency conversion stage coupled to the switching stage.

In a second aspect of the invention, a mixer circuit is provided, comprising: a voltage-to-current converter stage; a switching stage comprising a plurality of switches, the switching stage being coupled with the voltage-to-current converter stage to controlled passing electrical current from the voltage-to-current converter stage through the switches; and a frequency conversion stage coupled to the switching stage.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1A shows a block level representation of the architecture of a SSB mixer circuit built in accordance to a first embodiment of the present invention.

FIG. 1B shows a block level representation of the architecture of a SSB mixer circuit built in accordance to a second embodiment of the present invention.

FIG. 2 shows the frequency spectrum of a MB-OFDM UWB.

FIG. 3 shows a block level representation of the architecture for a MB-OFDM UWB system according to an embodiment of the present invention.

FIG. 4A shows a circuit level implementation of the SSB mixer circuit.

FIG. 4B shows digital logic used to generate various switching signals.

FIG. 4C shows a r network optimization of switches in the load adjusting stage of the SSB mixer circuit.

FIG. 5 shows a graph illustrating the switching time required for the three operation modes of the SSB mixer circuit.

FIG. 6 illustrates the output spectrum of VOP and VON when the SSB mixer circuit is operating in a down-converter mode.

FIG. 7 illustrates the output spectrum of VOP and VON when the SSB mixer circuit is operating in an up-converter mode.

FIG. 8 illustrates the output spectrum of VOP and VON when the SSB mixer circuit is operating in the amplifier mode.

FIG. 9 shows a die microphotograph of a tri-mode SSB mixer circuit fabricated onto a silicon substrate.

FIG. 10 shows the output spectrum of a fabricated circuit operating in the down-converter mode.

FIG. 11 shows the output spectrum of the fabricated circuit operating in the amplifier mode.

FIG. 12 illustrates the frequency hopping performance of the fabricated circuit switched from the amplifier operating mode to the down-converter operating mode.

FIG. 13 summarizes the performance of the fabricated circuit.

### DETAILED DESCRIPTION

As used herein the terms connected and coupled are intended to include both direct and indirect connection and coupling, respectively.

Exemplary embodiments of a Single Side Band (SSB) mixer circuit for fast frequency hopping carrier generation in a Multi-Band Orthogonal Frequency Division Multiplexing Ultra-Wide Band (MB-OFDM UWB) system are described in detail below with reference to the accompanying figures. It will be appreciated that, the exemplary embodiments described below can be modified in various aspects without changing the essence of the invention.

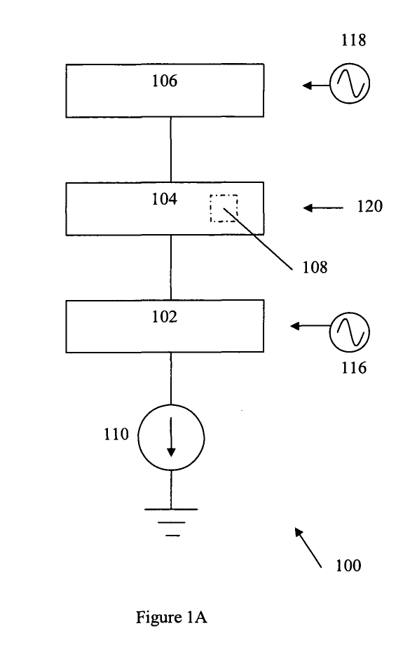

FIG. 1A shows a block level representation of the architecture of a SSB mixer circuit 100 built in accordance to a first embodiment of the present invention, for a MB-OFDM UWB system. The architecture of the SSB mixer circuit 100 includes the following functional blocks, namely a voltage-to-current converter stage 102, a switching stage 104, a frequency conversion stage 106 and a controlled passing electrical current 110. The switching stage 104 includes a plurality of switches 108, where the switching stage 104 is coupled with the voltage-to-current converter stage 102 to the controlled passing electrical current 110 through the plurality of switches 108. The frequency conversion stage 106 is coupled to the switching stage 104.

In use, the voltage-to-current converter stage 102 will convert around 528 MHz frequency band spacing input voltage signals 116 to current signals. The voltage-to-current converter stage 102 is also referred to as the transconductor stage. The switching stage 108 controls the polarity of the differential current signal coupled to the frequency conversion stage 106. Current switching ensures minimal signal loss and enables a faster frequency hopping function. At the same time, current switching provides a better isolation and hence much lower level of image frequency.

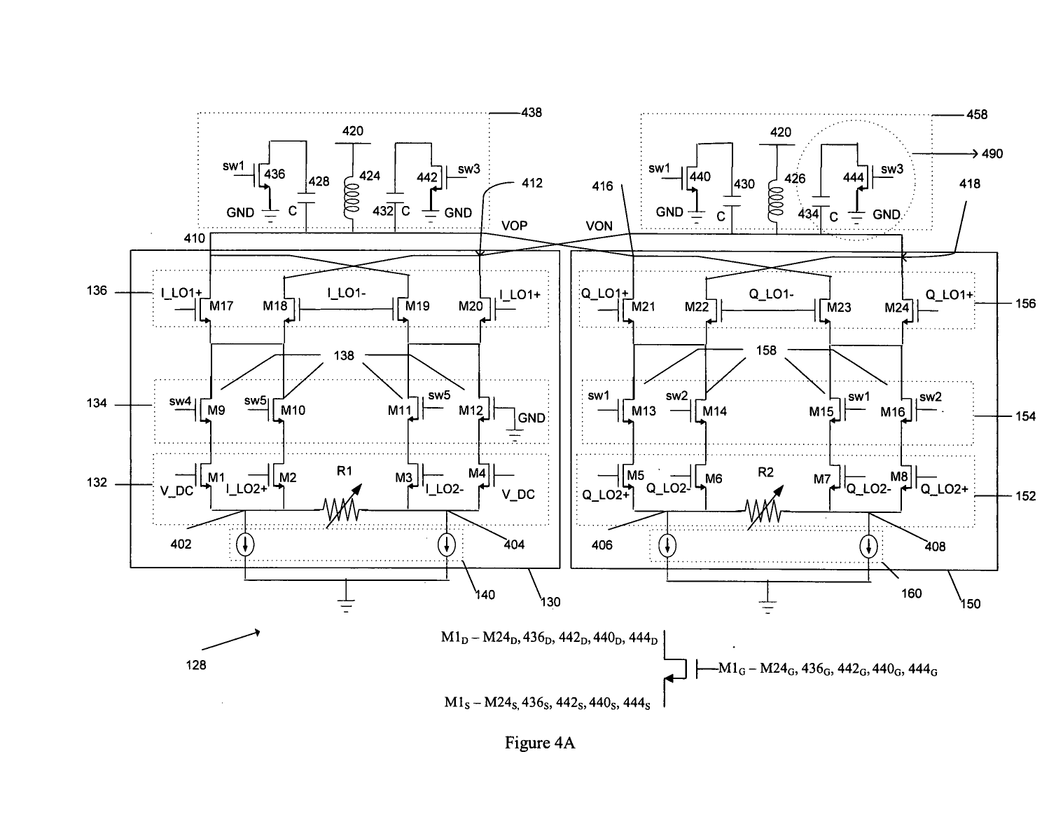

The switching stage 104 serves to realize the frequency hopping function of the SSB mixer circuit 100 by selecting the polarity of the 528 MHz current signals that are electrically communicated from the voltage-to-current converter stage 102 to the frequency conversion stage 106. Frequency hopping is effected by control signals 120, where the control signals 120 will in turn generate internal control signals (not shown), which will be further elaborated below with reference to FIG. 4A. The frequency conversion stage 106 will receive a carrier frequency input 118 of around 3.96 GHz, where the carrier frequency input 118 will be modulated by the 528 MHz current signals.

FIG. 1B shows a block level representation of the architecture of a SSB mixer circuit 128 built in accordance to a second embodiment of the present invention, for a MB-OFDM UWB system. The second embodiment includes a first mixer circuit 130 and a second mixer circuit 150.

The architecture of the first mixer circuit 130 includes the following functional blocks, namely a voltage-to-current converter stage 132, a switching stage 134, a frequency conversion stage 136 and a controlled passing electrical current 140. The switching stage 134 includes a plurality of switches 138, where the switching stage 134 is coupled with the voltage-to-current converter stage 132 to the controlled passing electrical current 140 through the plurality of switches 138. The frequency conversion stage 136 is coupled to the switching stage 134.

Similarly, the architecture of the second mixer circuit 150 includes the following functional blocks, namely a voltage-to-current converter stage 152, a switching stage 154, a frequency conversion stage 156 and a controlled passing electrical current 160. The switching stage 154 includes a plurality of switches 158, where the switching stage 154 is coupled with the voltage-to-current converter stage 152 to the controlled passing electrical current 160 through the plurality of switches 158. The frequency conversion stage 156 is coupled to the switching stage 154.

The same input signals 116, 118 and 120 that are applied to the SSB mixer circuit 100 are also similarly applied to the SSB mixer circuit 128.

In use, the voltage-to-current converter stages 132 and 152 will convert the around 528 MHz band spacing frequency input voltage signals 116 to current signals and each of the plurality of switches 138 and 158 will control the polarity of the differential current signal coupled from the voltage-to-current converter stages 132 and 152 to the frequency conversion stages 136 and 156. The voltage-to-current converter stages 132 and 152 are also referred to as the transconductor stages. Current switching ensures minimal signal loss and enables a faster frequency hopping function. At the same time, current switching provides a better isolation and hence much lower level of frequency hopping.

The switching stages 134 and 154 serve to realize the frequency hopping function of the SSB mixer circuit 128 by selecting the polarity of the 528 MHz current signals that are electrically communicated from the voltage-to-current converter stages 132 and 152 to the respective frequency conversion stages 136 and 156. Frequency hopping is effected by the control signals 120. The frequency conversion stages 136 and 156 will each receive the carrier frequency input 118 of around 3.96 GHz, where the carrier frequency input 118 will be modulated by the 528 MHz current signals.

A circuit level implementation of the SSB mixer circuit 128 will be described later, with reference to FIG. 4A.

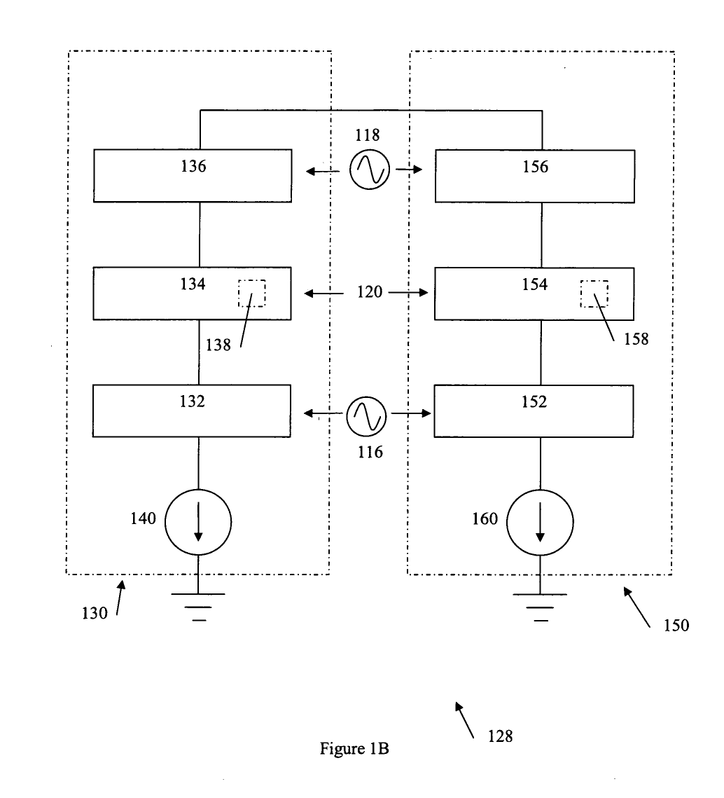

FIG. 2 shows the frequency spectrum 200 of the MB-OFDM UWB. The spectrum 200 is divided into bands 202 that have a bandwidth of around 528 MHz. The SSB mixer circuit 100 (FIG. 1) uses the frequency bands 202 that are within the first band group 210, where the carrier frequency 118 is around 3.96 GHz (3960 MHz). The side bands 204 and 206 are both spaced around 528 MHz from the carrier frequency 118, to define an upper side band 204 that has a frequency of around 4.488 GHz and a lower side band 206 that has a frequency of around 3.432 GHz.

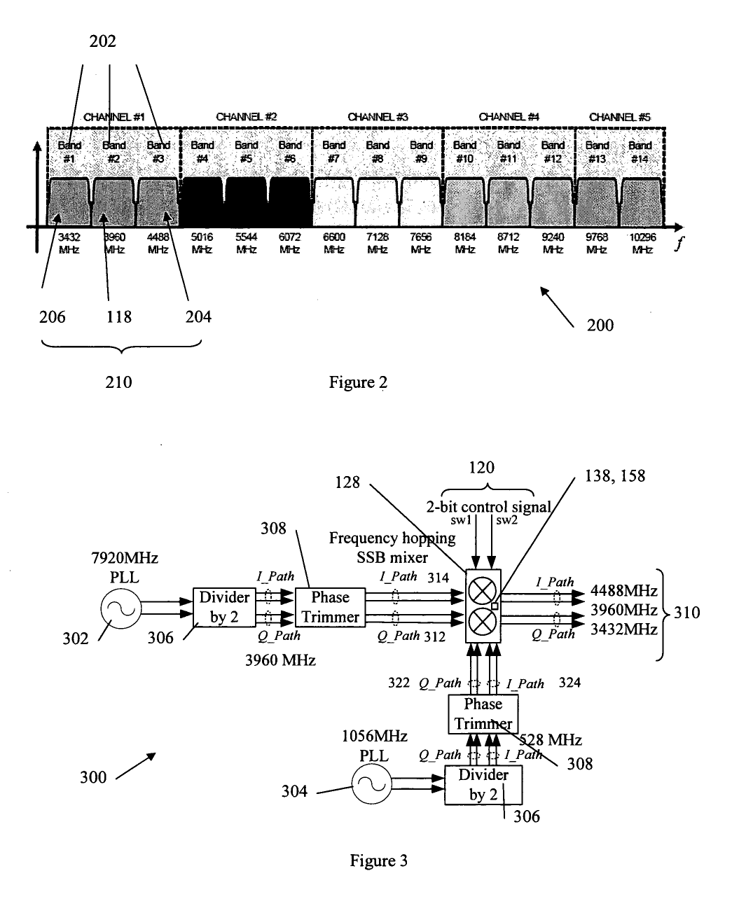

FIG. 3 shows a block level representation of the architecture for the MB-OFDM UWB system 300 according to an embodiment of the present invention, where the objective is to have a fast frequency hopping circuit where the hopping time between the different frequencies within a band group is less than about 9.47 ns and where the output of the desired frequencies have spurious tones that are below −50 dBc.

The architecture of the system 300 includes the following functional blocks, a first phase locked loop (PLL) frequency synthesiser 302 operating at around 7920 MHz, a second phase locked loop (PLL) frequency synthesiser 304 operating at around 1056 MHz and the SSB mixer circuit 128. The first and second synthesizers 302 and 304 are coupled to the SSB mixer circuit 128 via their respective frequency dividers 306 and phase trimmers 308.

As a first input, the SSB mixer circuit 128 receives quadrature differential signal inputs 312 and in-phase differential signal inputs 314, both having a carrier frequency of around 3.96 GHz, from the first PLL frequency synthesiser 302 after processing by the respective frequency divider 306 and phase trimmer 308. As a second input, the SSB mixer circuit 128 receives quadrature differential signal inputs 322 and in-phase differential signal inputs 324, both having a modulation frequency of around 528 MHz, from the second PLL frequency synthesiser 306 after processing by the respective frequency divider 306 and phase trimmer 308.

Depending on the 2-bit control signals 120, the output 310 from the SSB mixer circuit 128 facilitates fast frequency hopping capability to generate one of the three output frequencies 310 of around 3.432 GHz, around 3.96 GHz or around 4.488 GHz. Compared with known MB-OFDM UWB systems, the MB-OFDM UWB system 300 can be realized with fewer PLL frequency synthesizers, thus avoiding signal leakage occurring in the multiple paths used in multiplexers present in the known MB-OFDM UWB system. Further, as the frequency hopping is achieved using switches 138 and 158 that are integrated into the SSB mixer circuit 128, the architectural complexity of the SSB mixer circuit 128 is reduced when compared with known SSB mixers that require auxiliary circuitry to achieve the frequency hopping function.

FIG. 4A shows the circuit level implementation of the SSB mixer circuit 128 of FIG. 1B.

The first mixer circuit 130 and the second mixer circuit 150 are double balanced and have a symmetrical arrangement with each other, implemented by a plurality of transistors (M1 to M24) that are suitably connected, as described in further detail below.

The plurality of transistors of the voltage-to-current converter stage 132 of the first mixer circuit 130 includes a first transistor M1, a second transistor M2, a third transistor M3 and a fourth transistor M4. Control terminals M1_{G}, M2_{G}, M3_{G} and M4_{G} of the first, second, third and fourth transistors, M1 to M4, are respectively coupled to a supply voltage V_DC, a first differential in-phase input signal having a first frequency I_LO2+, a second differential in-phase input signal having the first frequency I_LO2−; and the supply voltage V_DC.

The plurality of transistors of the voltage-to-current converter stage 152 of the second mixer circuit 150 includes a ninth transistor M5, a tenth transistor M6, an eleventh transistor M7 and a twelfth transistor M8. Control terminals M5_{G}, M6_{G}, M7_{G} and M8_{G} of the ninth, tenth, eleventh and twelfth transistors, M5-M8 are respectively coupled to a first differential quadrature input signal having a first frequency Q_LO2+, a second differential quadrature input signal having the first frequency Q_LO2−, the second differential quadrature input signal having the first frequency Q_LO2− and the first differential quadrature input signal having the first frequency Q_LO2+.

Each of the voltage-to-current converter stages 132 and 152 includes a resistor R1 and R2 respectively, where the resistor R1 and R2 can be a variable resistor.

The resistor R1 of the voltage-to-current converter stage 132 of the first mixer circuit 130 is connected between a first controlled terminal M2_{S} of the second transistor M2 and a first controlled terminal M3_{S} of the third transistor M3.

The resistor R2 of the voltage-to-current converter stage 152 of the second mixer circuit 150 is connected between a first controlled terminal M6_{S} of the tenth transistor M6 and a first controlled terminal M7_{S} of the eleventh transistor M7.

A first controlled terminal M1_{S} of the first transistor M1 is coupled with the first controlled terminal M2_{S} of the second transistor M2. Further, the first controlled terminal M1_{S} of the first transistor M1 and the first controlled terminal M2_{S} of the second transistor M2 are coupled with a node reference potential 402.

The first controlled terminal M3_{S} of the third transistor M3 is coupled with a first controlled terminal M4_{S} of the fourth transistor M4. Further, the first controlled terminal M3_{S} of the third transistor M3 and the first controlled terminal M4_{S} of the fourth transistor M2 are coupled with a node reference potential 404.

A first controlled terminal M5_{S} of the ninth transistor M5 is coupled with the first controlled terminal M6_{S} of the tenth transistor M6. Further, the first controlled terminal M5_{S} of the ninth transistor M5 and the first controlled terminal M6_{S} of the tenth transistor M6 are coupled with a node reference potential 406.

The first controlled terminal M7_{S} of the eleventh transistor M7 is coupled with a first controlled terminal M8_{S} of the twelfth transistor M8. Further, the first controlled terminal M7_{S} of the eleventh transistor M7 and the first controlled terminal M8_{S} of the twelfth transistor M8 are coupled with a node reference potential 408.

In the SSB mixer circuit 128, the nodes reference potentials 402, 404, 406 and 408 are electrical connection points which are respectively connected to reference potential GND through controlled passing electrical current sources 140A, 140B, 160A and 160B.

Turning to the switching stages 134 and 154, the switching stage 134 of the first mixer circuit 130 includes a plurality of switches 138, while the switching stage 154 of the second mixer circuit 150 includes a plurality of switches 158. In the SSB mixer circuit 128, the switches 138 and 158 include transistors M9-M16.

The plurality of switches 138 of the first mixer circuit 130 includes a first switch M9, a second switch M10, a third switch M11 and a fourth switch M12.

Control terminals M9_{G}, M10_{G}, M11_{G} and M12_{G} of the first, second, third and fourth switches, M9-M12 are respectively coupled to a fourth switching signal sw4, a fifth switching signal sw5, the fifth switching signal sw5 and the reference potential GND.

A first controlled terminal M9_{S} of the first switch M9 is coupled with a second controlled terminal M1_{D} of the first transistor M1. A first controlled terminal M10_{S} of the second switch M10 is coupled with a second controlled terminal M2_{D} of the second transistor M2. A first controlled terminal M11_{S} of the third switch M11 is coupled with a second controlled terminal M3_{D} of the third transistor M3. A first controlled terminal M12_{S} of the fourth switch M12 is coupled with a second controlled terminal M4_{D} of the fourth transistor M4.

The plurality of switches 158 of the second mixer circuit 150 includes a fifth switch M13, a sixth switch M14, a seventh switch M15 and an eighth switch M16.

Control terminals M13_{G}, M14_{G}, M15_{G} and M16_{G} of the fifth, sixth, seventh and eighth switches, M13-M16 are respectively coupled to the first switching signal sw1, a second switching signal sw2, the first switching signal sw1 and the second switching signal sw2.

A first controlled terminal M13_{S} of the fifth switch M13 is coupled with a second controlled terminal M5_{D} of the ninth transistor M5. A first controlled terminal M14_{S} of the sixth switch M14 is coupled with a second controlled terminal M6_{D} of the tenth transistor M6. A first controlled terminal M15_{S} of the seventh switch M15 is coupled with a second controlled terminal M7_{D} of the eleventh transistor M7. A first controlled terminal M16_{S} of the eighth switch M16 is coupled with a second controlled terminal M8_{D} of the twelfth transistor M8.

The frequency conversion stages 136 and 156 include a plurality of transistors M17-M24.

The plurality of transistors M17-M20 of the frequency conversion stage 136 of the first mixer circuit 130 includes a fifth transistor M17, a sixth transistor M18, a seventh transistor M19 and an eighth transistor M20.

Control terminals M17_{G}, M18_{G}, M19_{G} and M20_{G} of the fifth, sixth, seventh and eighth transistors, M17-M20, are respectively coupled to a first differential in-phase input signal having a second frequency I_LO1+, a second differential in-phase input signal having the second frequency I_LO1−, the second differential in-phase input signal having the second frequency I_LO1− and the first differential in-phase input signal having a second frequency I_LO1+.

A first controlled terminal M17_{S} of the fifth transistor M17 is coupled with a second controlled terminal M9_{D} of the first switch M9. A first controlled terminal M18_{S} of the sixth transistor M18 is coupled with a second controlled terminal M10_{D} of the second switch M10. A first controlled terminal M19_{S} of the seventh transistor M19 is coupled with a second controlled terminal M11_{D} of the third switch M11. A first controlled terminal M20_{S} of the eighth transistor M20 is coupled with a second controlled terminal M12_{D} of the fourth switch M12.

The plurality of transistors M21-M24 of the frequency conversion stage 156 of the second mixer circuit 150 includes a thirteenth transistor M21, a fourteenth transistor M22, a fifteenth transistor M23 and a sixteenth transistor M24.

Control terminals M21_{G}, M22_{G}, M23_{G} and M24_{G} of the thirteenth, fourteenth, fifteenth and sixteenth transistors, M21-M24, are respectively coupled to a first differential quadrature input signal having a second frequency Q_LO1+, a second differential quadrature input signal having the second frequency Q_LO1−, the second differential quadrature input signal having the second frequency Q_LO1−; and the first differential quadrature input signal having the second frequency Q_LO1+.

A first controlled terminal M21_{S} of the thirteenth transistor M21 is coupled with a second controlled terminal M13_{D} of the fifth switch M13. A first controlled terminal M22_{S} of the fourteenth transistor M22 is coupled with a second controlled terminal M14_{D} of the sixth switch M14. A first controlled terminal M23_{S} of the fifteenth transistor M23 is coupled with a second controlled terminal M15_{D} of the seventh switch M15. A first controlled terminal M24_{S} of the sixteenth transistor M24 is coupled with a second controlled terminal M16_{D} of the eighth switch M16.

The frequency conversion stage 136 of the first mixer circuit 130 includes a first output terminal 410 and a second output terminal 412. Similarly, the frequency conversion stage 156 of the second mixer circuit 150 includes a first output terminal 418 and a second output terminal 416. In other words, each of the frequency conversion stages 136 and 156 comprises both a first output terminal (410 and 418) and a second output terminal (412 and 416) respectively.

The first output terminal 410 of the frequency conversion stage 136 of the first mixer circuit 130 is coupled with the second output terminal 416 of the frequency conversion stage 156 of the second mixer circuit 150, while the second output terminal 412 of the frequency conversion stage 136 of the first mixer circuit 130 is coupled with the first output terminal 418 of the frequency conversion stage 156 of the second mixer circuit 150.

A second controlled terminal M17_{D} of the fifth transistor M17 is coupled with the first output terminal 410 of the frequency conversion stage 136 of the first mixer circuit 130, while a second controlled terminal M18_{D} of the sixth transistor M18 is coupled with the second output terminal 412 of the frequency conversion stage 136 of the first mixer circuit 130. A second controlled terminal M19_{D} of the seventh transistor M19 is coupled with the first output terminal 410 of the frequency conversion stage 136 of the first mixer circuit 130, while a second controlled terminal M20_{D} of the eighth transistor M20 is coupled with the second output terminal 412 of the frequency conversion stage 136 of the first mixer circuit 130.

Turning to the second mixer circuit 150, a second controlled terminal M21_{D} of the thirteenth transistor M21 is coupled with the second output terminal 416 of the frequency conversion stage 156 of the second mixer circuit 150. A second controlled terminal M22_{D} of the fourteenth transistor M22 is coupled with the first output terminal 418 of the frequency conversion stage 156 of the second mixer circuit 150, while a second controlled terminal M23_{D} of the fifteenth transistor M23 is coupled with the second output terminal 416 of the frequency conversion stage of the second mixer circuit. A second controlled terminal M24_{D} of the sixteenth transistor M24 is coupled with the first output terminal 418 of the frequency conversion stage 156 of the second mixer circuit 150.

A first controlled terminal M17_{S} of the fifth transistor M17 is coupled with a second controlled terminal M9_{D} of the first switch M9. A first controlled terminal M18_{S} of the sixth transistor M18 is coupled with a second controlled terminal M10_{D} of the second switch M10. A first controlled terminal M19_{S} of the seventh transistor M19 is coupled with a second controlled terminal M11_{D} of the third switch M11. A first controlled terminal M20_{S} of the eighth transistor M20 is coupled with a second controlled terminal M12_{D} of the fourth switch M12.

Each of the first mixer circuit 130 and the second mixer circuit 150 further includes a loading adjusting stage 438 and 458 to adjust the frequency response of the loading. The loading adjusting stage 438 of the first mixer circuit 130 is coupled with the first output terminal 410 of the first mixer circuit 130. The loading adjusting stage 458 of the second mixer circuit 150 is coupled with the first output terminal 418 of the second mixer circuit 150.

Each of the loading adjusting stages 438 and 458 includes an inductance 424 and 426 coupled between the respective first output terminal 410 and 418 and a reference potential 420.

In addition to the inductance 424, the loading adjusting stage 438 of the first mixer circuit 130 includes capacitors 428 and 432 that are coupled between the first output terminal 410 and the reference potential GND. Adjusting switches 436 and 442 are respectively coupled between the capacitors 428 and 432 and the reference potential GND.

In addition to the inductance 420, the loading adjusting stage 458 of the second mixer circuit 130 includes capacitors 430 and 434 that are coupled between the first output terminal 418 and the reference potential GND. Adjusting switches 440 and 444 are respectively coupled between the capacitors 430 and 434 and the reference potential GND.

As such, each of the loading adjusting stages 438 and 458 includes at least one capacitance (428, 432, 430 and 444) coupled between the respective first output terminal 410 and 418, and the reference potential GND. Each of the loading adjusting stages 438 and 458 include at least one adjusting switch (436, 442, 440 and 444) coupled between the at least one capacitance (428, 432, 430 and 444) and the reference potential GND.

The inductor (424; 426)-capacitor (436, 432; 430, 434) tanks resonant frequencies are shifted with the respective loading adjusting stages 438 and 458 to maximize output signals at differential output nodes VOP and VON.

In the SSB mixer circuit 128 of FIG. 4A where the adjusting switches (436, 442, 440 and 444) are transistors, each of the loading adjusting stages (438 and 458) includes a first capacitance (428 and 430), a first adjusting switch (436 and 440), a second capacitance (432 and 434) and a second adjusting switch (442 and 444). A first terminal of the first capacitance (428 and 430) is coupled with the respective first output terminal (410 and 418). For the first adjusting switch (436 and 440), a first controlled terminal (436_{S} and 440_{S}) is coupled with the reference potential GND, a second controlled terminal (436_{D} and 440_{D}) is coupled with a respective second terminal of the first capacitance (428 and 430), and a control input (436_{G} and 440) is coupled with the first switching signal sw1. A first terminal of the second capacitance (432 and 434) is coupled with the respective first output terminal (410 and 418). For the second adjusting switch (442 and 444), a first controlled terminal (442_{S} and 444_{S}) is coupled with the reference potential GND, a second controlled terminal (442_{D} and 444_{D}) is coupled with a respective second terminal of the second capacitance (432 and 434), and a control input (442_{G} and 444_{G}) is coupled with the third switching signal sw3.

I_LO1+ and I_LO1− are the in-phase differential input carrier signals of frequency f1 of around 3.96 GHz, while Q_LO1+ and Q_LO1− are the quadrature differential input carrier signals at the same frequency f1 of around 3.96 GHz. Similarly, I_LO2+ and I_LO2− are the in-phase differential input modulation signals of frequency f2 of around 528 MHz, while Q_LO2+ and Q_LO2− are the quadrature differential input modulation signals at the same frequency f2 of around 528 MHz. The supply voltage V_DC is the bias voltage signal. A typical sample bias voltage is around 1.1V to around 1.35V. VOP and VON are the differential output nodes for the SSB mixer circuit 128, where VOP outputs the signal emitted from both the first output terminal 410 of the first mixer circuit 130 and the second output terminal 416 of the second mixer circuit 150, while VON outputs the signal emitted from both the first output terminal 418 of the second mixer circuit 150 and the second output terminal 412 of the first mixer circuit 130.

The first switching signal sw1 and the second switching signal sw2 are 2-bit configuration signals, having logic levels “0” or “1”. The switching signals sw1 and sw2 are used to control which of the three operation modes: an up-converter, a down-converter or an amplifier, the tri-mode SSB mixer circuit 128 will function in. FIG. 4B shows digital logic 480 used to generate the switching signals sw1, sw2, sw3, sw4 and sw5 in the SSB mixer circuit 128 (FIG. 4A). The digital logic 480 includes a NOR gate 482 and two NOT gates 484 and 486. The first and the second switching signals sw1 and sw2 are input into the NOR gate 482 while only the second switching signal sw2 is input into the NOT gate 484. The first and the second switching signals sw1 and sw2 generate the fourth switching signal sw4 at the output of the NOR gate 482, and the fourth switching signal sw4 is input into the NOT gate 486 to generate the fifth switching signal sw5 at the output of the NOT gate 486. The second switching signal sw2 also generates the third switching signal sw3 at the output of the NOT gate 484.

Returning to FIG. 4A, setting the first switching signal to sw1=0 and the second switching signal to sw2=0, which in turn sets the third switching signal to sw3=1; the fourth switching signal sw4=1; and the fifth switching signal to sw5=0, will cause the tri-mode SSB mixer circuit 128 to operate as an amplifier to produce an amplified output frequency of f1, i.e. an amplified around 3.96 GHz carrier signal, at the output terminals VOP and VON. The third switching signal sw3 is only used to shift the resonant peak of the respective inductor (424; 426)-capacitor (436, 432; 430, 434) tanks in the loading adjusting stages 438 and 458. In this manner, the third switching signal sw3 ensures maximum output swing appearing at the differential output nodes VOP and VON when the SSB mixer circuit 128 performs frequency band hopping.

Setting the first switching signal to sw1=0 and the second switching signal to sw2=1, which in turn sets the third switching signal to sw3=0; the fourth switching signal sw4=0; and the fifth switching signal to sw5=1, will cause the tri-mode SSB mixer circuit 128 to operate in the up-converter mode to obtain an output signal of frequency (f1+f2), i.e. an around 3.96 GHz+528 MHz signal, at the output terminals VOP and VON.

Setting the first switching signal to sw1=1 and the second switching signal to sw2=0, which in turn sets the third switching signal to sw3=1; the fourth switching signal sw4=0; and the fifth switching signal to sw5=1, will cause the tri-mode SSB mixer circuit 128 to operate in the down-converter mode to obtain an output signal of frequency (f1−f2), i.e. an around (3.96 GHz−528 MHz) signal, at the output terminals VOP and VON. The scenario where the first and the second switching signals are set to sw1=sw2=1 is not used in the tri-mode SSB mixer circuit 128. In the amplifier mode, the tri-mode SSB mixer circuit 128 consumers half the current that is used in the other two modes, the up-converter and the down-converter modes.

For the first channel 210 (FIG. 2), the transistors M1-M8, which form the voltage-to-current converter stages 132 and 152, convert input side bands 204 and 206 of around 528 MHz input voltage signals to current signals. The transistors M17-M24, which form the frequency conversion stages 136 and 156, realise the frequency conversion function of the tri-mode SSB mixer circuit 128 to switch the around 528 MHz current signals across a load (not shown) using the 3.96 GHz carrier frequency 118 (FIG. 2).

Transistors M9-M16, which form the switching stages 134 and 154, function as means to realise the frequency hopping function of the tri-mode SSB mixer circuit 128. The transistors M9-M16 select the polarity of the around 528 MHz current signals that enter the transistors M17 to M24, based on the switching signals sw1 and sw2 (as earlier described with reference to the digital logic gate representational level 480), thereby controlling the signal output at the output terminals VOP and VON.

As opposed to known SSB mixer systems which use auxiliary mixer circuitry, the switching stages 134 and 136 (implemented by cascading the transistors M9-M16) are integrated into the tri-mode SSB mixer circuit 128. Also, different from known SSB mixer systems, the switching stages 134 and 136 are not used to switch voltage signals, but current signals. Current switching has the advantage of providing minimal signal loss and a faster frequency hopping performance. Current switching also achieves a better isolation performance and hence a lower level of image frequency. Cascading the various transistors, M9-M16, further facilitates better isolation performance, while the symmetrical circuit arrangement of the SSB mixer circuit 128 further facilitates the lower level of image frequency by ensuring that the differential input signals (Q_LO1+, Q_LO1−, I_LO1+ and I_LO1−) and (Q_LO2+, Q_LO2−, I_LO2+ and I_LO2−) are well matched.

Image rejection performance depends mainly on the phase mismatch and amplitude imbalance of input in-phase differential signals and quadrature differential input modulation signals. Thus, the double balanced structure and symmetry of the first mixer circuit 130 and the second mixer circuit 150 of the tri-mode SSB mixer circuit 128 minimize the probability of introducing phase and amplitude mismatch to the differential input modulation signals at frequency f2 (around 528 MHz), Q_LO2+, Q_LO2−, I_LO2+ and I_LO2−, and the differential input carrier signals at frequency f1 (around 3.96 GHz) Q_LO1+, Q_LO1−, I_LO1+ and I_LO1−. When the MB-OFDM UWB system 300 (FIG. 3) employs the SSB mixer circuit 128, the phase trimmers 308 (FIG. 3) serve to compensate any unavoidable residual amplitude and phase mismatch present in the SSB mixer circuit 128 and thus improve the image rejection performance of the tri-mode SSB mixer circuit 128. Thus, the tri-mode SSB mixer circuit 128 can obtain better image rejection performance. The symmetrical structure, degeneration resistance (not shown) in the transconductance (gm) (not shown) stage and good isolation performance ensure that the output of the desired frequencies have lower spurious tones when compared with conventional SSB mixers.

As there is reduced switching losses in the input of the tri-mode SSB mixer circuit 128, the input swing for the differential input modulation signals at frequency f2 (around 528 MHz), Q_LO2+, Q_LO2−, I_LO2+ and I_LO2− can be reduced. It will also be appreciated that the size of the transistors M9-M16 can be carefully optimised, through known techniques, to obtain a compromise between hopping speed and limited voltage headroom.

The inductors 424 and 426 in each of the loading adjusting stages 438 and 458 shunts the respective first adjusting switch (436, 440)-capacitor (428, 430) and the respective second adjusting switch (442, 432)-capacitor (432, 434) arrangements. Thus, the response frequency of the loading adjusting stages 438 and 458 can be adjusted according to the output frequencies selected by the first and the second switching signals sw1 and sw2. In this way, maximum output swing and better sideband rejection is achieved. However, the conversion gain and frequency hopping selection of the tri-mode SSB mixer circuit 128 suffer from the decreased quality factor of the capacitors 428, 432,430 & 434 due respectively to the adjusting switches 436, 442, 440 and 444. To alleviate this problem, the switches 436, 442, 440 and 444 are optimised in a π network 490 (also refer FIG. 4C) to reduce the equivalent resistance, thus improving quality factor and hence the output signal level.

The variable resistors R1 and R2, both having resistive values of 60 to 250Ω, are used to adjust the conversion gain of the tri-mode SSB mixer circuit 128 to ensure that the performance is the same under various temperature and corner conditions.

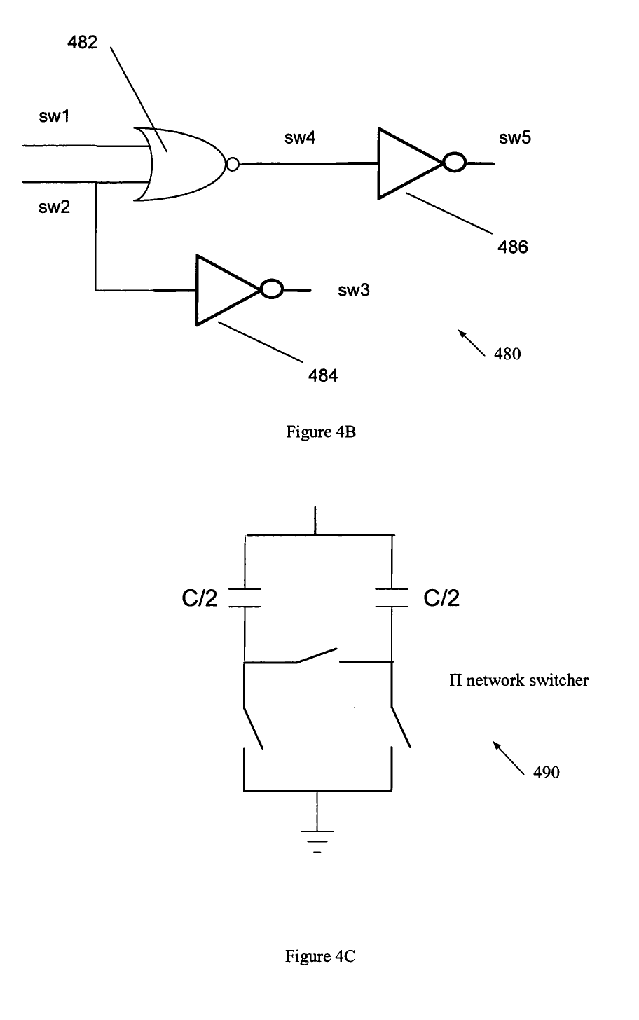

A simulation under ADS2004A with the SSB mixer circuit 128 being fabricated using Fujisu 90 nm CMOS technology was conducted. The simulation results are discussed with reference to FIGS. 5 to 8, where the carrier frequency, f1=around 3.96 GHz and the modulation frequency, f2=around 528 MHz.

FIG. 5 shows a graph 502 plotting the output (in volts) at VOP and VON of the SSB mixer circuit 128 (FIG. 2) against time (in ns); and a graph 504 of a plot of the input (in volts) first and second switching signals sw1 and sw2 against time (in ns). The graph 502 shows the corresponding output VOP and VON in response to the first and second switching signals sw1 and sw2 shown in the graph 504.

The transient simulation results of FIG. 5 show the switching time required for the three operation modes: the up-converter (f1+f2), the down-converter (f1−f2) or the amplifier (f1).

When the first and the second switching signals change respectively from sw1=1 and sw2=0 to sw1=0 and sw2=1, the time needed for the output frequency signal to change from (f1−f2) to (f1+f2) is around 1.5 ns, as indicated using reference numeral 506.

When the second switching signal changes from sw2=1 to sw2=0, while the first switching signal remains at sw1=0, the time needed for the output frequency signal to change from (f1−f2) to (f1) is around 2 ns, as indicated using reference numeral 508.

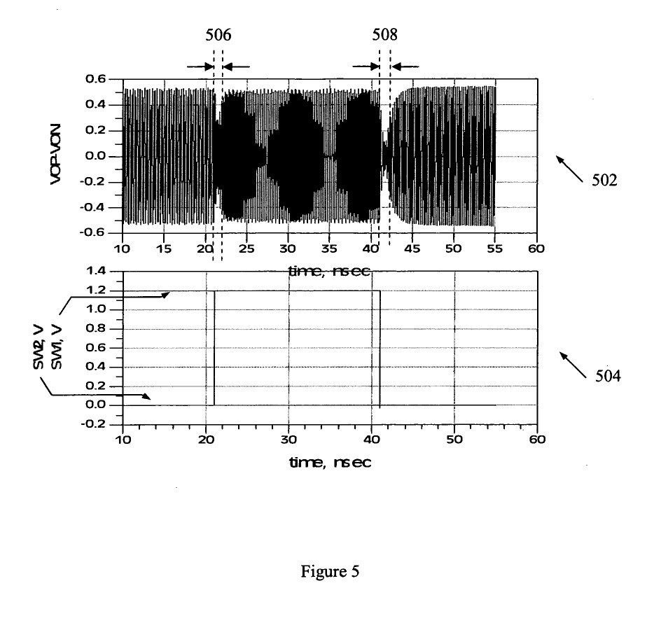

FIG. 6 illustrates the output spectrum of VOP and VON when the SSB mixer circuit 128 (FIG. 4A) is operating in the down-converter (f1−f2) mode. A graph 602 plots the output power of VOP and VON in dB against frequency in GHz. The graph 602 demonstrates that the output spectrum in the down converter (f1−f2) mode can achieve image rejection of around 50 dB.

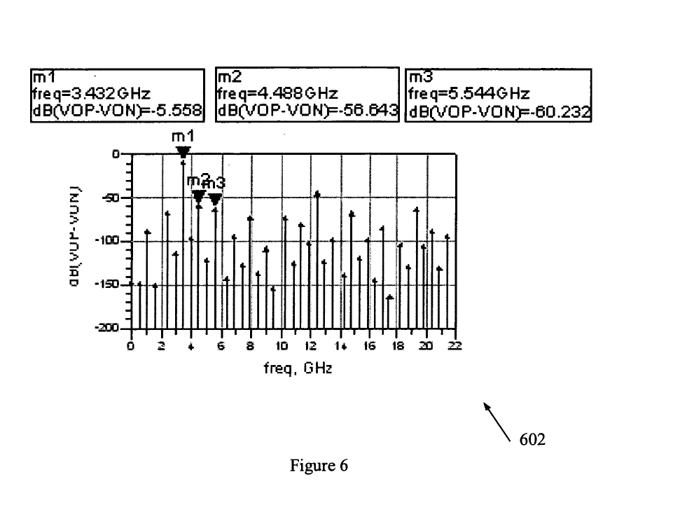

FIG. 7 illustrates the output spectrum of VOP and VON when the SSB mixer circuit 128 (FIG. 4A) is operating in the up-converter (f1+f2) mode. A graph 702 plots the output power of VOP and VON in dB against frequency in GHz. The graph 702 demonstrates that the output spectrum in the up-converter (f1+f2) mode can achieve image rejection of around 50 dB.

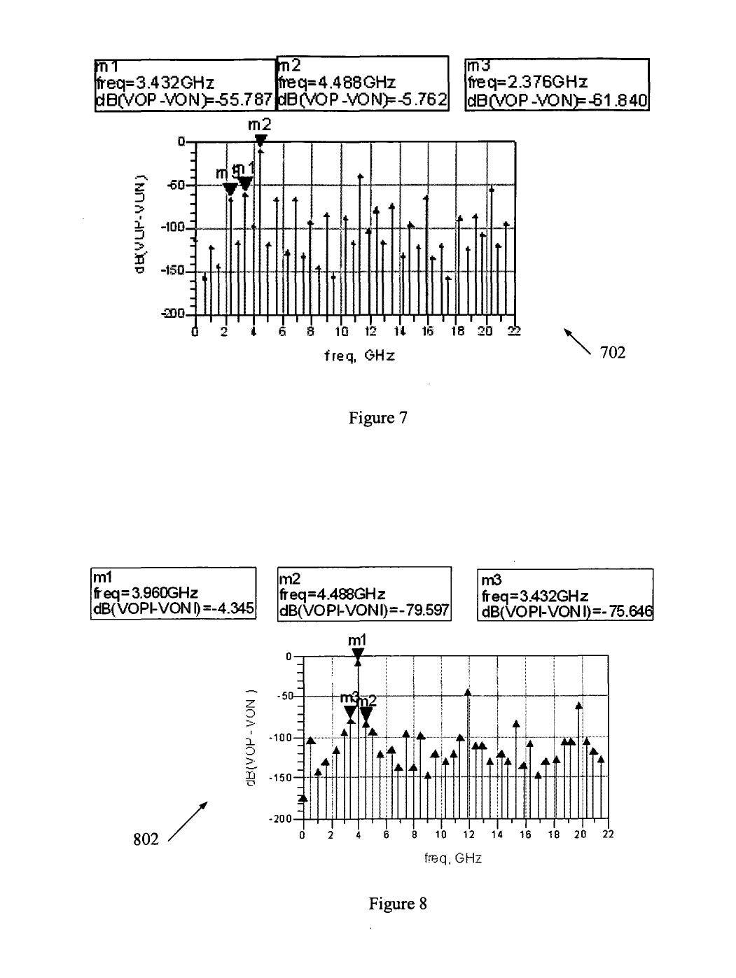

FIG. 8 illustrates the output spectrum of VOP and VON when the SSB mixer circuit 128 (FIG. 4A) is operating in the amplifier (f1) mode. A graph 802 plots the output power of VOP and VON in dB against frequency in GHz. The graph 802 demonstrates that the carrier frequency f1 of around 3.96 GHz (see m1) is amplified a greater extent that the other respective side band frequencies m3 and, m2 of 3.432 GHz and 4.488 GHz.

The above simulation results demonstrate that the tri-mode SSB mixer circuit 128 (FIG. 4A) can switch output frequencies in less than 9 ns to meet the specification for a fast switching multi-band UWB system.

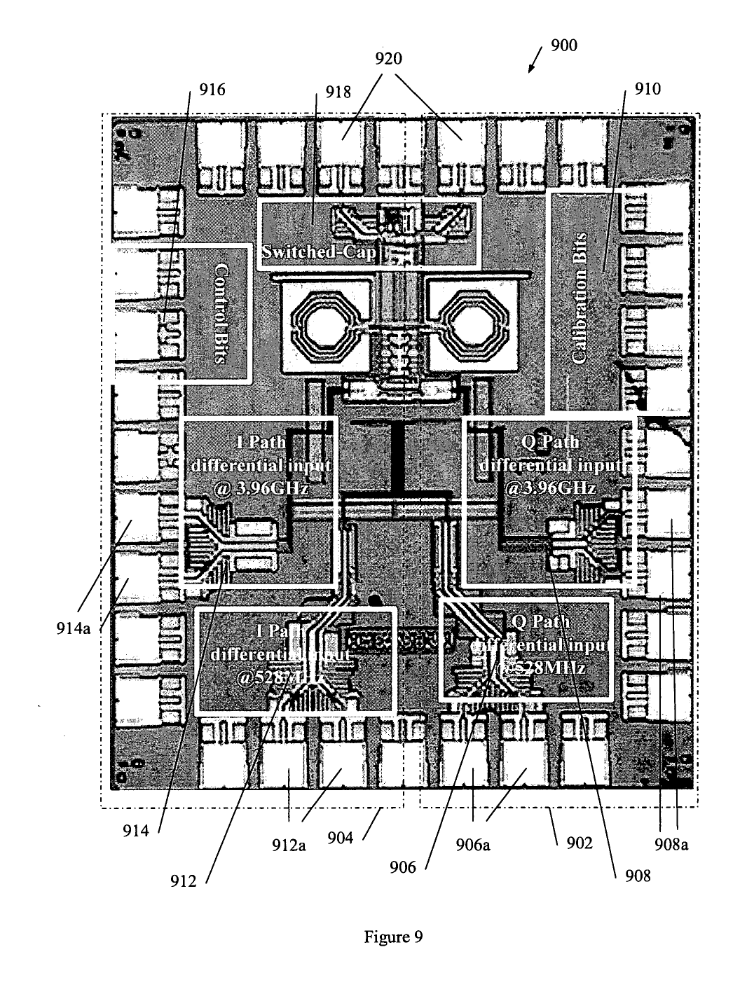

FIG. 9 shows a die microphotograph of the tri-mode SSB mixer circuit 128 (FIG. 4A) implemented with Fujisu 90 nm CMOS technology fabricated onto a silicon substrate through known methods to those skilled in the art. Prior to fabrication, the parasitic parameter of the physical layout was carefully estimated which included modelling important on-chip traces.

The die size of the core circuit 900 is 2×1.8 mm².

To obtain better device matching performance, the core circuit 900 has symmetrical matching layouts 902 and 904. Portions 906 and 912 respectively designate the input signal paths for the quadrature differential signals and the in-phase differential signals, both signals being of band spacing frequency at around 528 MHz. The corresponding input pads for the portions 906 and 912 are designated 906a and 912a respectively. Portions 908 and 914 respectively designate the input signal paths for the quadrature differential signals and the in-phase differential signals, both signals being of carrier frequency at around 3.96 GHz. The corresponding input pads for the portions 908 and 914 are designated 908a and 914a respectively. Portion 920 designates the output pads for the core circuit 900. Portion 910 designates signal paths for calibration bits. Portion 916 designates signal paths for first and second switching signals sw1 and sw2 (FIG. 4A). Portion 918 designates the circuitry for the adjusting switch-capacitor arrangements in the loading adjusting stages 438 (FIG. 4A) and 458 (FIG. 4A).

The tri-mode SSB mixer in the core circuit 900 draws about 7 mA under an about 1.2V supply. The voltage supply can be adjusted from about 1.1V to about 1.35V with an operating temperature from about −40° C. to about 85° C.

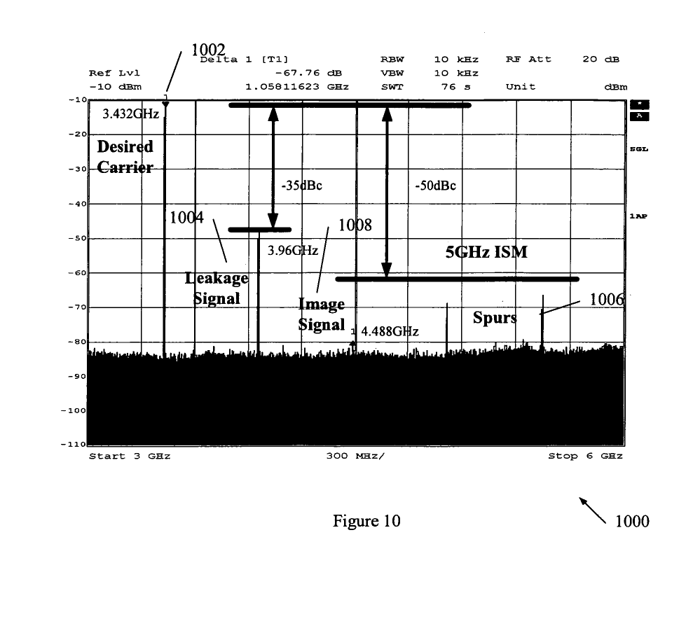

The results of tests conducted on the fabricated circuit 900 are discussed with reference to FIGS. 10 to 13, where a carrier frequency, f1=around 3.96 GHz and a modulation frequency, f2=around 528 MHz were used.

FIG. 10 shows the output spectrum of the fabricated circuit 900 (FIG. 9) when the tri-mode SSB mixer is operating in the down-converter mode. The output spectrum is a graph 1000 of output power against frequency, where the desired output 1002 frequency is at around 3.432 GHz. The measured image rejection 1008 achieves up to 67 dBc using externally phase trimmed quadrature input signals. As the second band 1004 (or LO) leakage at frequency around 3.96 GHz is better than −35 dBc and the third harmonic spurious level 1006 at around 5.544 GHz is −54 dBc, WLAN 802.11a applications are not affected.

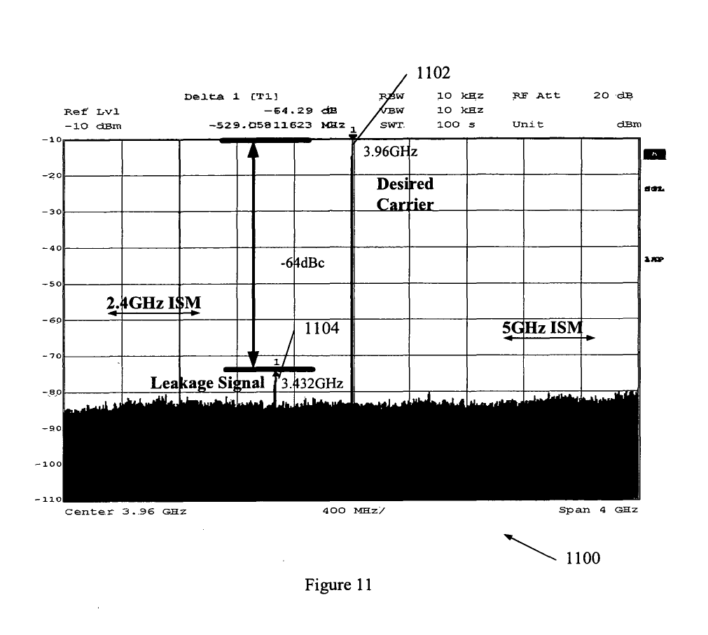

FIG. 11 shows the output spectrum of the fabricated circuit 900 (FIG. 9) when the tri-mode SSB mixer is operating in the amplifier mode. The output spectrum is a graph 1100 of output power against frequency, where a 3.96 GHz carrier signal 1102 is generated. In the amplifier mode, the consumption current is reduced to around 3.5 mA. The spur 1104 located at 3.432 GHz is as low as −64 dBc.

For the third band application (Figure not shown), the measured image rejection performance of the up converted output is about −50 dBc, while the LO leakage at around 3.96 GHz level is −35 dBc. The third harmonic spurious level at around 2.374 GHz is only −53 dBc.

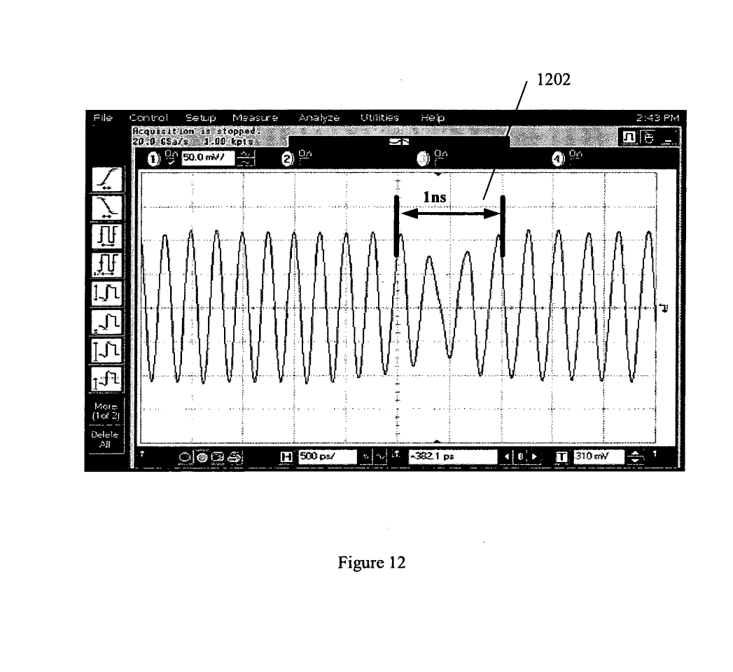

FIG. 12 illustrates the frequency hopping performance of the fabricated circuit 900 (FIG. 9) when the tri-mode SSB mixer is switched from the amplifier operating mode to the down-converter operating mode. The hopping time 1202 is less than 1 ns which is well below the requirement for a MB-OFDM UWB system.

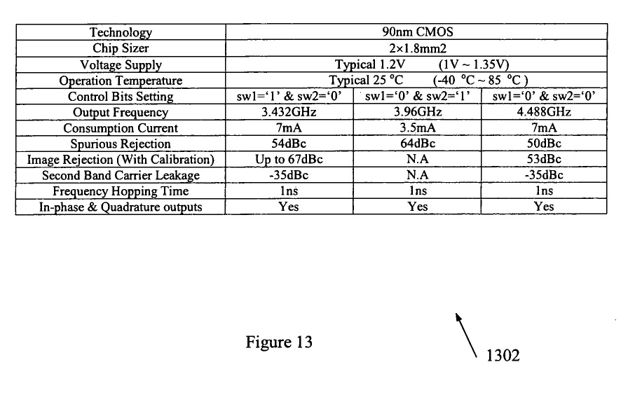

The performance summary of the fabricated circuit 900 (FIG. 9) is tabulated 1302 as shown in FIG. 13. The measured results demonstrate that the tri-mode SSB mixer circuit 128 (FIG. 4A) has good linearity and fast frequency hopping performance for MB-OFDM UWB applications.

From the results presented with reference to FIGS. 10 to 13, it will be observed that the performance of the actual fabricated circuit 900 agrees well with the simulation results discussed earlier with reference to FIGS. 5 to 8.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A mixer circuit, comprising:
a voltage-to-current converter stage;
a switching stage comprising a plurality of switches, the switching stage being coupled with the voltage-to-current converter stage to controlled passing electrical current from the voltage-to-current converter stage through the switches; and
a frequency conversion stage coupled to the switching stage.

2. The mixer circuit of claim 1,
wherein the voltage-to-current converter stage comprises a first transistor, a control terminal of which is coupled to a supply voltage;
a second transistor, a control terminal of which is coupled to a first differential in-phase input signal having a first frequency;
a third transistor, a control terminal of which is coupled to a second differential in-phase input signal having the first frequency; and
a fourth transistor, a control terminal of which is coupled to the supply voltage.

3. (canceled)

4. The mixer circuit of claim 2, wherein the voltage-to-current converter stage comprises a resistor connected between a first controlled terminal of the second transistor and a first controlled terminal of the third transistor.

5-7. (canceled)

8. The mixer circuit of claim 2, wherein a first controlled terminal of the first transistor and a first controlled terminal of the second transistor are coupled with a reference potential.

9. (canceled)

10. The mixer circuit of claim 2, wherein a first controlled terminal of the third transistor and a first controlled terminal of the fourth transistor are coupled with a reference potential.

11. The mixer circuit of claim 2,
wherein the switches comprise a first switch, a control terminal of which is coupled to a fourth switching signal;
a second switch, a control terminal of which is coupled to a fifth switching signal;
a third switch, a control terminal of which is coupled to the fifth switching signal; and
a fourth switch, a control terminal of which is coupled to a reference potential.

12. (canceled)

13. The mixer circuit of claim 11,
wherein a first controlled terminal of the first switch is coupled with a second controlled terminal of the first transistor;
a first controlled terminal of the second switch is coupled with a second controlled terminal of the second transistor; a first controlled terminal of the third switch is coupled with a second controlled terminal of the third transistor; a first controlled terminal of the fourth switch is coupled with a second controlled terminal of the fourth transistor.

14. The mixer circuit of claim 11,
wherein the frequency conversion stage comprises:
a fifth transistor, a control terminal of which is coupled to a first differential in-phase input signal having a second frequency;
a sixth transistor, a control terminal of which is coupled to a second differential in-phase input signal having a second frequency;
a seventh transistor, a control terminal of which is coupled to the second differential in-phase input signal having the second frequency;
an eighth transistor, a control terminal of which is coupled to the first differential in-phase input signal having a second frequency.

15. (canceled)

16. The mixer circuit of claim 14,
wherein a first controlled terminal of the fifth transistor is coupled with a second controlled terminal of the first switch; and
a first controlled terminal of the sixth transistor is coupled with a second controlled terminal of the second switch; a first controlled terminal of the seventh transistor is coupled with a second controlled terminal of the third switch; a first controlled terminal of the eighth transistor is coupled with a second controlled terminal of the fourth switch.

17. The mixer circuit of claim 14,
wherein the frequency conversion stage comprises a first output terminal and a second output terminal, wherein
a second controlled terminal of the fifth transistor is coupled with the first output terminal;
a second controlled terminal of the sixth transistor is coupled with the second output terminal;
a second controlled terminal of the seventh transistor is coupled with the first output terminal; and
a second controlled terminal of the eighth transistor is coupled with the second output terminal.

18. (canceled)

19. The mixer circuit of claim 17, further comprising: a loading adjusting stage to adjust the frequency response of the loading; wherein the loading adjusting stage is coupled with the first output terminal, wherein the loading adjusting stage comprises:
a first capacitance, a first terminal of which is coupled with the first output terminal;
a first adjusting switch,
a first controlled terminal of which is coupled with the other reference potential;
a second controlled terminal of which is coupled with a second terminal of the first capacitance;
a control input of which is coupled with a first switching signal;
a second capacitance, a first terminal of which is coupled with the first output terminal;
a second adjusting switch,
a first controlled terminal of which is coupled with the other reference potential;
a second controlled terminal of which is coupled with a second terminal of the second capacitance;
a control input of which is coupled with a third switching signal; and
an inductance coupled between the first output terminal and a reference potential.

20-23. (canceled)

24. A mixer circuit arrangement, comprising:
a first mixer circuit, comprising:
a voltage-to-current converter stage;
a switching stage comprising a plurality of switches, the switching stage being coupled with the voltage-to-current converter stage to controlled passing electrical current from the voltage-to-current converter stage through the switches; and
a frequency conversion stage coupled to the switching stage;
a second mixer circuit, comprising:
a voltage-to-current converter stage;
a switching stage comprising a plurality of switches, the switching stage being coupled with the voltage-to-current converter stage to controlled passing electrical current from the voltage-to-current converter stage through the switches; and
a frequency conversion stage coupled to the switching stage.

25. (canceled)

26. The mixer circuit arrangement of claim 24,
wherein the voltage-to-current converter stage of the first mixer circuit comprises:
a first transistor, a control terminal of which is coupled to a supply voltage;
a second transistor, a control terminal of which is coupled to a first differential in-phase input signal having a first frequency;
a third transistor, a control terminal of which is coupled to a second differential in-phase input signal having the first frequency; and
a fourth transistor, a control terminal of which is coupled to the supply voltage.

27. The mixer circuit arrangement of claim 24,
wherein the voltage-to-current converter stage of the second mixer circuit comprises:
a ninth transistor, a control terminal of which is coupled to a first differential quadrature input signal having a first frequency;
a tenth transistor, a control terminal of which is coupled to a second differential quadrature input signal having the first frequency;
an eleventh transistor, a control terminal of which is coupled to the second differential quadrature input signal having the first frequency; and
a twelfth transistor, a control terminal of which is coupled to the first differential quadrature input signal having the first frequency.

28. The mixer circuit arrangement of claim 27, wherein each voltage-to-current converter stage of the voltage-to-current converter stages comprises a resistor,
wherein the resistor of the voltage-to-current converter stage of the first mixer circuit is connected between a first controlled terminal of the second transistor and a first controlled terminal of the third transistor;
wherein the resistor of the voltage-to-current converter stage of the second mixer circuit is connected between a first controlled terminal of the tenth transistor and a first controlled terminal of the eleventh transistor.

29-31. (canceled)

32. The mixer circuit arrangement of claim 26, wherein a first controlled terminal of the first transistor and a first controlled terminal of the second transistor are coupled with a reference potential.

33. (canceled)

34. The mixer circuit arrangement of claim 26, wherein a first controlled terminal of the third transistor and a first controlled terminal of the fourth transistor are coupled with a reference potential.

35. (canceled)

36. The mixer circuit arrangement of claim 27, wherein a first controlled terminal of the ninth transistor and a the first controlled terminal of the tenth transistor are coupled with a reference potential.

37. (canceled)

38. The mixer circuit arrangement of claim 27, wherein a first controlled terminal of the eleventh transistor and a first controlled terminal of the twelfth transistor are coupled with a reference potential.

39. (canceled)

40. The mixer circuit arrangement of claim 26, wherein the plurality of switches of the first mixer circuit comprises:
a first switch, a control terminal of which is coupled to a fourth switching signal;
a second switch, a control terminal of which is coupled to a fifth switching signal;
a third switch, a control terminal of which is coupled to the fifth switching signal; and
a fourth switch, a control terminal of which is coupled to a reference potential.

41. The mixer circuit arrangement of claim 40, wherein
a first controlled terminal of the first switch is coupled with a second controlled terminal of the first transistor;
a first controlled terminal of the second switch is coupled with a second controlled terminal of the second transistor;
a first controlled terminal of the third switch is coupled with a second controlled terminal of the third transistor; and
a first controlled terminal of the fourth switch is coupled with a second controlled terminal of the fourth transistor.

42. The mixer circuit arrangement of claim 27, wherein the plurality of switches of the second mixer circuit comprises:
a fifth switch, a control terminal of which is coupled to a first switching signal;
a sixth switch, a control terminal of which is coupled to a second switching signal;
a seventh switch, a control terminal of which is coupled to the first switching signal; and
an eighth switch, a control terminal of which is coupled to the second switching signal.

43. The mixer circuit arrangement of claim 42,
wherein a first controlled terminal of the fifth switch is coupled with a second controlled terminal of the ninth transistor;
a first controlled terminal of the sixth switch is coupled with a second controlled terminal of the tenth transistor;
a first controlled terminal of the seventh switch is coupled with a second controlled terminal of the eleventh transistor; and
a first controlled terminal of the eighth switch is coupled with a second controlled terminal of the twelfth transistor.

44. (canceled)

45. The mixer circuit arrangement of claim 40, wherein the frequency conversion stage of the first mixer circuit comprises:
a fifth transistor, a control terminal of which is coupled to a first differential in-phase input signal having a second frequency;
a sixth transistor, a control terminal of which is coupled to a second differential in-phase input signal having the second frequency;
a seventh transistor, a control terminal of which is coupled to the second differential in-phase input signal having the second frequency; and
an eighth transistor, a control terminal of which is coupled to the first differential in-phase input signal having a second frequency.

46. The mixer circuit arrangement of claim 45, wherein
a first controlled terminal of the fifth transistor is coupled with a second controlled terminal of the first switch;
a first controlled terminal of the sixth transistor is coupled with a second controlled terminal of the second switch;
a first controlled terminal of the seventh transistor is coupled with a second controlled terminal of the third switch;
a first controlled terminal of the eighth transistor is coupled with a second controlled terminal of the fourth switch.

47. The mixer circuit arrangement of claim 42, wherein the frequency conversion stage of the second mixer circuit comprises:
a thirteenth transistor, a control terminal of which is coupled to a first differential quadrature input signal having a second frequency;
a fourteenth transistor, a control terminal of which is coupled to a second differential quadrature input signal having the second frequency;
a fifteenth transistor, a control terminal of which is coupled to the second differential quadrature input signal having the second frequency; and
a sixteenth transistor, a control terminal of which is coupled to the first differential quadrature input signal having the second frequency.

48. The mixer circuit arrangement of claim 47, wherein
a first controlled terminal of the thirteenth transistor is coupled with a second controlled terminal of the fifth switch;
a first controlled terminal of the fourteenth transistor is coupled with a second controlled terminal of the sixth switch;
a first controlled terminal of the fifteenth transistor is coupled with a second controlled terminal of the seventh switch;
a first controlled terminal of the sixteenth transistor is coupled with a second controlled terminal of the eighth switch.

49. The mixer circuit arrangement of claim 47,
wherein each frequency conversion stage of the frequency conversion stages comprises a first output terminal and a second output terminal, wherein the first output terminal of the frequency conversion stage of the first mixer circuit is coupled with the second output terminal of the frequency conversion stage of the second mixer circuit;
wherein the second output terminal of the frequency conversion stage of the first mixer circuit is coupled with the first output terminal of the frequency conversion stage of the second mixer circuit.

50. (canceled)

51. The mixer circuit arrangement of claim 49, wherein
a second controlled terminal of the fifth transistor is coupled with the first output terminal of the frequency conversion stage of the first mixer circuit;
a second controlled terminal of the sixth transistor is coupled with the second output terminal of the frequency conversion stage of the first mixer circuit;
a second controlled terminal of the seventh transistor is coupled with the first output terminal of the frequency conversion stage of the first mixer circuit; and
a second controlled terminal of the eighth transistor is coupled with the second output terminal of the frequency conversion stage of the first mixer circuit.

52. The mixer circuit arrangement of claim 49, wherein
a second controlled terminal of the thirteenth transistor is coupled with the second output terminal of the frequency conversion stage of the second mixer circuit;
a second controlled terminal of the fourteenth transistor is coupled with the first output terminal of the frequency conversion stage of the second mixer circuit;
a second controlled terminal of the fifteenth transistor is coupled with the second output terminal of the frequency conversion stage of the second mixer circuit; and
a second controlled terminal of the sixteenth transistor is coupled with the first output terminal of the frequency conversion stage of the second mixer circuit.

53. The mixer circuit arrangement of claim 49,
wherein each of the first mixer circuit and the second mixer circuit further comprises a loading adjusting stage to adjust the frequency response of the loading;
wherein the loading adjusting stage of the first mixer circuit is coupled with the first output terminal of the first mixer circuit;
wherein the loading adjusting stage of the second mixer circuit is coupled with the first output terminal of the second mixer circuit.

54-56. (canceled)

57. The mixer circuit arrangement of claim 53, wherein each of the loading adjusting stages comprises:
a first capacitance, a first terminal of which is coupled with the respective first output terminal;
a first adjusting switch,
a first controlled terminal of which is coupled with the other reference potential;
a second controlled terminal of which is coupled with a respective second terminal of the first capacitance;
a control input of which is coupled with a first switching signal;
a second capacitance, a first terminal of which is coupled with the respective first output terminal;
a second adjusting switch,
a first controlled terminal of which is coupled with the other reference potential;
a second controlled terminal of which is coupled with a respective second terminal of the second capacitance;
a control input of which is coupled with a third switching signal; and
an inductance coupled between the first output terminal and a reference potential.
